(19) United States
(12) Patent Application Publication
(10) Pub. No.: US 2008/0211429 A1
(43) Pub. Date: Sep. 4, 2008

(54) LED lamp

(75) Inventor: Kazuhisa Saito, Kashiwa-shi (JP)

Correspondence Address: RABIN & Berdo, PC, 1101 14TH STREET, NW, SUITE 500, WASHINGTON, DC, 20005, US

(73) Assignees: Kazuhisa Saito, Chiba (JP); Kenichi Yoshikawa, Tokyo (JP)

(21) Appl. No.: 11/802,420

(22) Filed: May 22, 2007

(30) Foreign Application Priority Data
Mar. 2, 2007 (JP) 2007-052536

(51) Int. Cl. H05B 37/00; H01K 1/30

(52) U.S. Cl. 315/312; 313/110

(57) ABSTRACT

An improved LED lamp not suffering from excessive heat generation with bright illuminating property, includes an LED array having one or more of LED devices arranged, a mounting base for mounting the LED array thereon, and a light guide member extending to cover the LED array on the mounting base, the light guide member being made of white translucent acrylic resin having a transmittance from 60% to 88%. Where the light guide member has lens function and ultraviolet absorbing function, the light emitted from the lamp can be expanded well with containing less ultraviolet rays.

### BACKGROUND OF THE INVENTION

1. Field of the Invention

This invention relates to an LED (Light Emitting Diode) lamp using LED devices for illumination.

2. Description of Related Art

As LED lamps using LED devices, some LED lamps have been known publicly, and one of such LED lamps has a feature in which plural chip type LED devices are arrayed on a prescribed mounting substrate and in which the mounting substrate is inserted in a bulb formed of glass or plastic resin.

The LED lamp as described above, however, are required to increase the number of the LED devices to obtain a certain degree of illuminance, and may raise a problem that consumption electric power of the entire apparatus becomes increased according to the required illuminance. This is because the LED lamp described above cannot utilize effectively the light emitted out of the LED devices. The LED lamp also has no solution against unwanted ultraviolet rays contained in the emitted light of the LED devices, and therefore raises a problem that the ultraviolet rays contained in the light emitted out of the LED devices may directly project on the users. The LED lamp also generates a large amount of heats from the LED devices in a chip type, and therefore, most of such an LED lamp requires a heat dissipation system such as a heat sink.

It is, in consideration of above situations, an object of the invention to provide an LED lamp capable of effectively utilizing light emitted out of the LED devices and preventing ultraviolet ray from projecting of the lamp.

### BRIEF SUMMARY OF THE INVENTION

The present invention provides an improved LED lamp not suffering from excessive heat generation with bright illuminating property. The LED lamp includes an LED array having one or more of LED devices arranged, a mounting base for mounting the LED array thereon, and a light guide member extending to cover the LED array on the mounting base, the light guide member being made of white translucent acrylic resin having a transmittance from 60% to 88%.

According to a preferred embodiment, the light emitted out of the LED devices are projected toward the light guide member, and enters into the light guide member. The light proceeding into the light guide member passes through the light guide member, but while going through the light guide member, components of ultraviolet rays are absorbed by the agent absorbing ultraviolet ray, and therefore, the LED lamp does not radiate unwanted ultraviolet ray.

Sign boards and lamp covers frequently use a white translucent acrylic resin to disperse the light emitted from the lamp and to extinguish the transparent appearance of the lamp in prior art. Such white translucent acrylic resin generally has transmittance merely around 50%, and the light guide member in this invention has much higher transmittance from 60% to 88%. This transparency provides effective illumination and lower consumption of electric power in comparison with a lamp with transmittance around 50%. This invented LED lamp can be driven with a lower current such as 60 to 80% of the rated current of the LED device, so that the LED lamp can reduce the power consumption and heat generation.

### BRIEF DESCRIPTION OF THE SEVERAL VIEWS OF THE DRAWINGS

The above and other objects, features and advantages of the present invention will become more apparent from the following description of the presently preferred exemplary embodiments of the invention taken in conjunction with the accompanying drawing, in which:

FIG. 1 is a cross section showing an LED lamp according to a first embodiment of the invention;

FIG. 2 is another cross section showing the LED lamp shown in FIG. 1;

FIG. 3 is a plan view showing a mounting base and an LED array according to the first embodiment;

FIG. 4 is a cross section showing a light guide member of the LED lamp according to the first embodiment of the invention;

FIG. 5 is a schematic cross section showing the LED lamp of the first embodiment;

FIG. 6 is a side view showing a modified LED lamp according to the invention;

FIG. 7 is a cross-sectional perspective view showing another LED lamp partly broken away;

FIG. 8 is a cross section showing the LED lamp shown in FIG. 7;

FIG. 9 is a cross-sectional perspective view showing yet another LED lamp partly broken away; and

FIG. 10 is a cross section showing the LED lamp shown in FIG. 9.

### DETAILED DESCRIPTION OF THE INVENTION

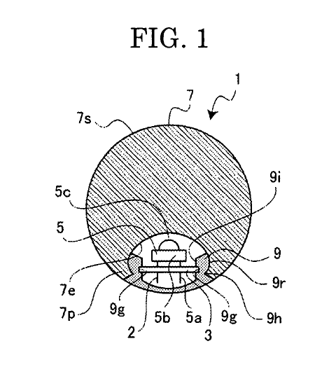

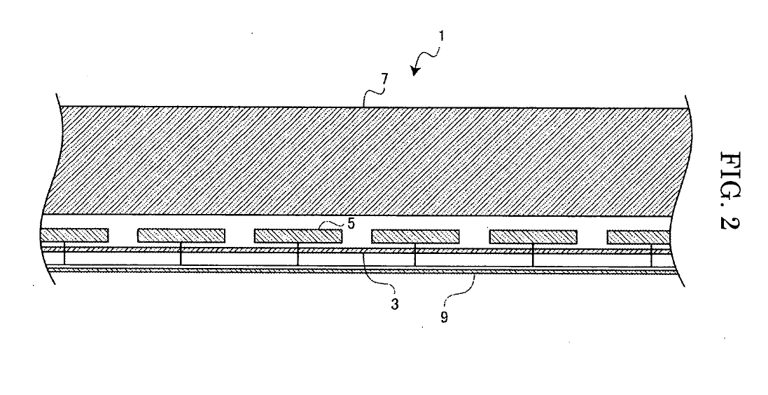

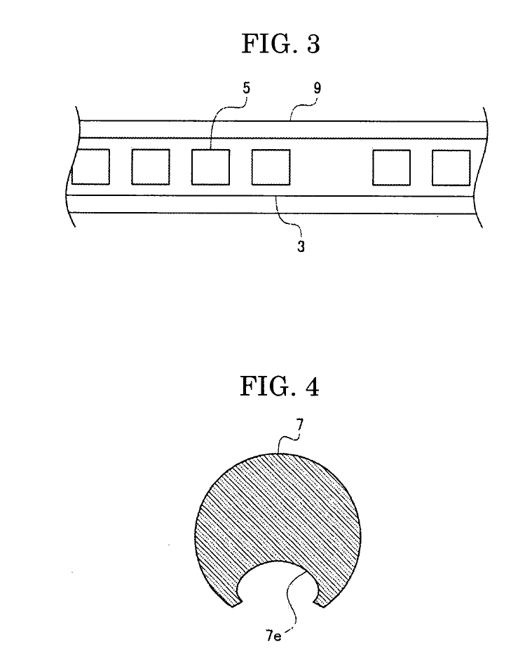

As shown in FIG. 1 and FIG. 2, an LED lamp 1 according to the first embodiment of the present invention includes a mounting base 9, an LED array 2 formed with a plurality of LED devices 5 and a circuit board 3 extending in a stripe plate shape, and a light guide member 7 made of a white translucent acrylic resin. The LED lamp 1 has a straight tube shape as to fit to ordinary fluorescent lamp sockets.

The LED array 2 is constituted of the circuit board 3 made of a rigid epoxy resin or the like, and a plurality of LED devices 5. The LED devices 5 can be formed of either a chip type or a bullet type, and in this embodiment, a bullet type LED device 5 having a square resin-made brim portion 5b and a center bullet shaped light emitting resin portion 5c can be used to form the LED array 2. A very tiny semiconductor light emitting chip, not shown, is placed in the center bullet shaped light emitting resin portion 5c in each LED device 5, and the light emitting chip is electrically connected to four leads 5a extending downward as to penetrate the circuit board 3. Two leads 5a out of four leads 5a are common and function as wires for either cathode or anode.

The circuit board 3 is a strip shaped plate extending along the longitudinal direction of the tube shaped light guide member 5. The circuit board 3 has circuit wiring and resistors or diode for flowing a fixed amount current, not shown. Each end of the transverse direction of the circuit board 3 is supported at a groove 9g made on an inner side wall 9i of the mounting base 9. Because the LED array 2 formed with the circuit board 3 is supported at the grooves 9g, the LED array 2 can create a space between the mounting base 9 and the LED array 2, so that heat generated at the LED array 2 can be dissipated easily through the air flowing in the space between the LED array 2 and the mounting base 9. Each end of the longitudinal direction of the circuit board is connected to a plug member, not shown, to be connected to a socket for power supply.

The bullet type LED devices 5 are arranged in line with a prescribed interval. The interval between the LED devices 5 can be 10 mm or more, depending on the illuminating power of the LED devices 5. If the LED devices 5 are able to illuminate further better, the intervals between the LED devices 5 can be longer without sacrificing brightness. Although in this embodiment the LED devices 5 are arranged in a line, the LED devices 5 can be arranged in plural lines or staggered manner, and although in this embodiment, the LED devices 5 are the same, various LED devices having different emitting color, size, direction, power can be mounted in one array. One LED array 1 may have plural LED arrays 2. The bullet type LED devices 5 have a feature that the LED device generates a smaller amount of heat that the chip type, so that the bullet type LED devices 5 are particularly suitable for the LED lamp 1 requiring low heat generation.

The mounting base 9 is made of a metal such as aluminum or the like and having a letter-U shape as to hold the LED array 2 inside. The inner side wall 9i of the mounting base 9 has the grooves 9g to fit to the edges of the circuit board 3. A top of the mounting base 9 is tapered, and an inclined surface formed at the top functions as a reflecting surface to increase the light amount emitted from the LED array 2. A groove 9h is formed on each outer wall 9r of the mounting base 9 for engaging a projecting portion 7p of the light guide member 7. Because the light guide member 7 is elastic, an opening size between the projecting portions 7p can be widened to render the mounting base 9 snapped into the opening portion of the light guide member 7.

The light guide member 7 has a tube shape extending straight and has a lower groove to render the mounting base 9 fitted in. When the mounting base 9 is fitted in the lower groove, the cross section of this LED lamp becomes nearly a disc shape, and the cross section of the light guide member becomes a wider crescent moon shape as shown in FIG. 1. The lower groove has a curved surface 7e surrounding the LED array 2 and more importantly functioning as a concave lens. The light guide member 7 is made of a white translucent acrylic resin having transmittance from 60% to 88%. The light guide member 7 is preferably made of a white translucent acrylic resin having transmittance in a range of 73% to 85%, more preferably, 78% to 80%. According to an experiment conducted by the inventors, the LED lamp of the invention created illumination of 20,000× or more.

The light guide member 7 preferably contains an agent absorbing ultraviolet rays to cut off radiation of the harmful ultraviolet rays. Such an absorbing agent can be any agent having a good solubility in the acrylic resin and indicating adequate property absorbing ultraviolet rays. Exemplified as such an absorbing agent are compounds induced from, e.g., benzophenone based resin, benzotriazole based resin, salicylic acid phenyle based resin, and benzoic acid phenyle based resin, having the maximum absorbing wavelength in a range of 240 to 380 nm. According to an experiment conducted by the inventors, the LED lamp of the invention cut approximately 98% of ultraviolet rays emitted from the LED devices. The light guide member 7 also preferably contains rubber based resin to enhance the flexibility to fit to the mounting base 9. Where the light guide member 7 contain a rubber based compound or an elastic resin containing Si such as a silicone rubber, the light guide member can improve the property against impacts, particularly, the property against impact at a lower temperature

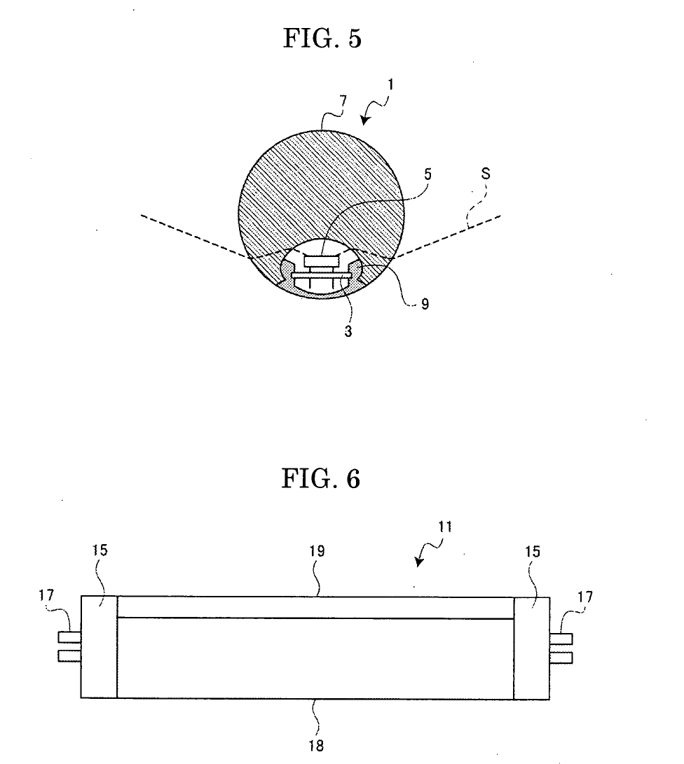

Because the light guide member 7 has a concave lens function, the light emitted from each LED device 5 is widely expanded, so that the light emitted out the LED lamp 1 radiates relatively uniformly in a well-dispersed manner as shown in FIG. 5. The light guide member 7 having the lens function has an adequate thickness in comparison with the mere cover of conventional lamps, and therefore, the light emitted from the LED lamp 1 does not contain most of ultraviolet components according to the absorbing function of the light guide member 7, thereby preventing harmful effects from occurring.

The LED lamp 7 is turned on by supplying the electric power through a plug member, not shown, to be connected to a socket for power supply. With this embodiment, each LED device 5 is driven with a relatively lower current, e.g., 60 to 80% of the rated current. This operation with the lower current brings power saving effects and reduction of heat generation. The lower current is simply produced by arrangements of resistors having relatively large resistance or diode more regulating the current. This operation with the lower current also brings a longer lifetime of the LED devices 5. As modified example, the LED lamp have a variable resistor or slide switch to control the illumination amount stepwise or linearly.

FIG. 6 shows a modified LED lamp 11 having a converter 15 at each end or a combination of a mounting base 19 and a light guide member 18, which are having substantially the same structure as described above. The converter 15 has a function to convert the power supply such as alternative current 100 or 110 V into, e.g., direct current 12 or 24 V suitable for each LED devices. The converted power is further supplied to the LED devices to drive the devices and emit the light. The converter 15 is housed with a plug 17 to be connected with a socket provided at ceiling or wall. Because the LED lamp 11 has the converters 15 and the plugs 17 at each end, the LED lamp 11 can be used in a compatible manner with existing facilities without changing any portion. The converter 15 can be formed on one side only.

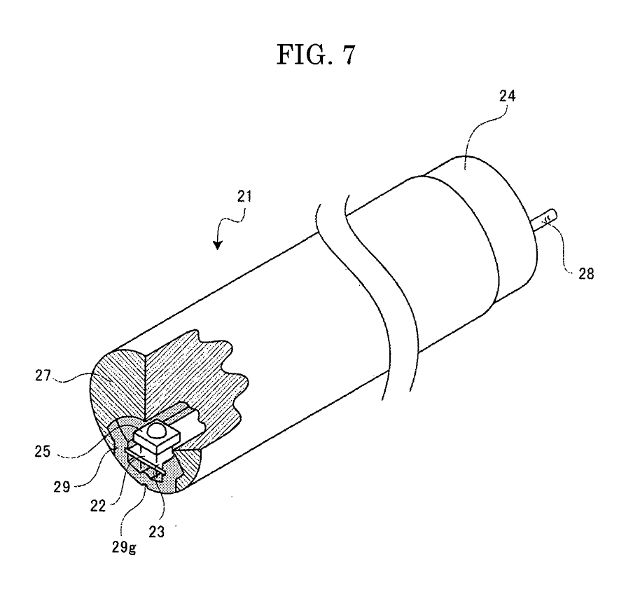

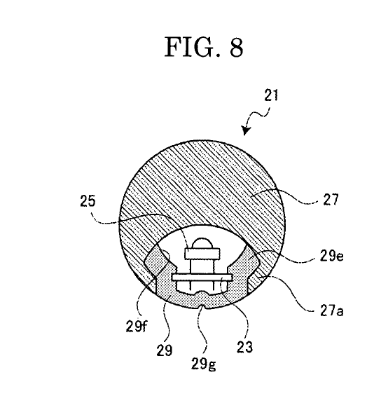

FIG. 7 and FIG. 8 show another LED lamp 21. The LED lamp 21 includes a mounting base 29, an LED array 22 formed with a plurality of LED devices 25 and a circuit board 23 extending in a stripe plate shape, and a light guide member 27 made of a white translucent acrylic resin. The LED lamp 21 has a straight tube shape, and at each end of this tube shape, the lamp 21 has a plug 24 and pins 28 for fitting to ordinary fluorescent lamp sockets.

The LED array 22 includes the LED devices 25 and the circuit board 23 are substantially the same structure as described above as the first embodiment, and therefore a merely duplicated description is omitted for the sake of simplicity. The light guide member 27 is also made of substantially the same resin described above. The differences in this LED lamp 21 is in the fitting structure between the light guide member and the mounting base. In this embodiment, the mounting base 29 has an opened surface 29f for functioning as a reflector at a top side of the mounting base 29, and this opening shape of the mounting base 29 also functions as engagement to the light guide member 27. The light guide member 27 has a projecting edge 27a in a curving manner along the circumferential direction when viewed with the cross section. The projection edge 27 is made of relatively straight lines, in comparison with the shape shown in FIG. 1, and therefore, the light guide member 27 can be easily molded by extrusion or the like.

The mounting base 9 has a small groove 29g at the center bottom. The small groove 29g has plural tiny through holes penetrating the thickness of the mounting base 9, so that the LED lamp 21 can have a suitable ventilation through the tiny through holes, thereby enjoying good heat dissipation.

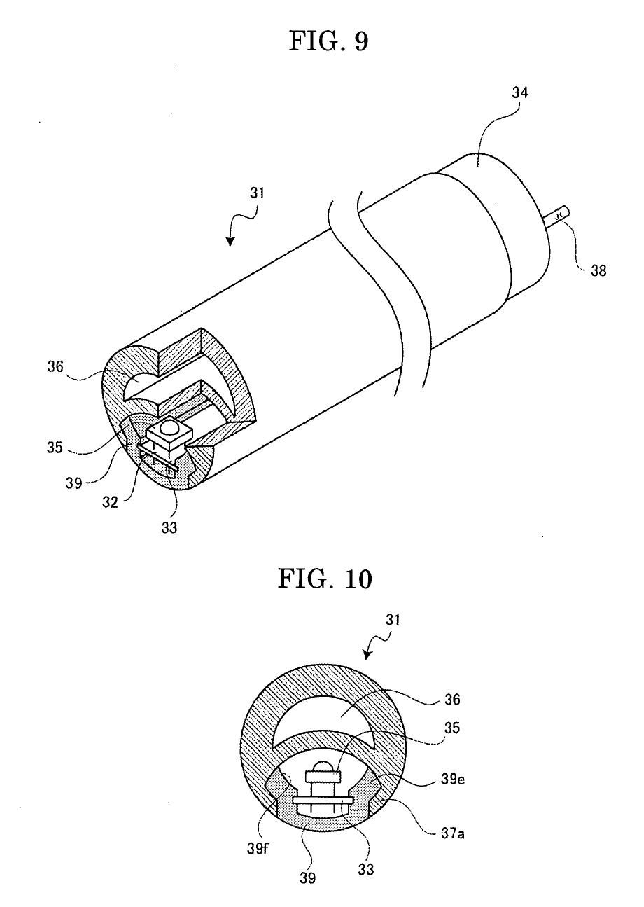

FIG. 9 and FIG. 10 show yet another LED lamp 31. The LED lamp 31 includes a mounting base 39, an LED array 32 formed with a plurality of LED devices 35 and a circuit board 33 extending in a stripe plate shape, and a light guide member 37 made of a white translucent acrylic resin. The LED lamp 31 has a straight tube shape, and at each end of this tube shape, the lamp 21 has a plug 34 and pins 38 for fitting to ordinary fluorescent lamp sockets.

The LED array 32 includes the LED devices 35 and the circuit board 33 are substantially the same structure as described above as the first embodiment, and therefore a merely duplicated description is omitted for the sake of simplicity. The light guide member 37 is also made of substantially the same resin described above. The differences in this LED lamp 31 is the structure of the light guide member 37. In this embodiment, the light guide member 37 has a crescent moon shaped hollow 36 inside the member itself. This hollow structure allows saving use of resin amount forming the light guide member 37, and also brings enhanced effects of lens functions brought by the light guide member 37. The fitting 'structure between the light guide member 37 and the mounting base 39 is substantially the same as that shown in FIGS. 7, 8.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An LED lamp comprising:
an LED array having one or more of LED devices arranged;
a mounting base for mounting the LED array thereon; and
a light guide member extending to cover the LED array on the mounting base, the light guide member being made of white translucent acrylic resin having a transmittance from 60% to 88%.

2. The LED lamp according to claim 1, wherein the white translucent acrylic resin includes an agent absorbing ultraviolet ray.

3. The LED lamp according to claim 1, wherein the white translucent acrylic resin includes silicon.

4. The LED lamp according to claim 1, wherein the LED array is formed with one or more of the LED devices and with a circuit board electrically connecting a power supply to each LED device.

5. The LED lamp according to claim 1, wherein the LED array is formed of one or more of the LED devices of a bullet type.

6. The LED lamp according to claim 1, wherein the light guide member having a lens shape to expand a beam emitted out of each LED device.

7. The LED lamp according to claim 5, wherein the light guide member having a hollow inside.

8. The LED lamp according to claim 1, wherein each LED device of the LED array is driven with a current in range of 60% to 80% of a rated current of the LED device.

9. An LED lamp comprising:
an LED array having one or more of LED devices arranged;
a mounting base for mounting the LED array thereon;
a light guide member extending to cover the LED array on the mounting base, the light guide member being made of white translucent acrylic resin having a transmittance from 60% to 88%; and
a plug member formed to be connected to an external socket for supplying power to each LED device of the LED array.

10. An LED lamp comprising:
an LED array having a plurality of LED devices arranged in line;
a mounting base extending straightly for mounting the LED array thereon;
a light guide member extending along the LED array to cover the LED array on the mounting base, the light guide member being made of white translucent acrylic resin having a transmittance from 60% to 88%; and
a pair of plug members formed at each end of the light guide member for supplying power to each LED device of the LED array.
